(19) United States
(12) Patent Application Publication
(10) Pub. No.: US 2008/0045667 A1
(43) Pub. Date: Feb. 21, 2008

(54) Process for preparing polyoxyalkylene glycol ethers using block polymers as demulsifiers

(75) Inventors: Alexander Snell, 4055 Basel (CH); Carsten Cohrs, 60316 Frankfurt (DE); Gabriele Oberendfellner, 84508 Burgkirchen (DE); Hildegard Freundl, 84508 Burgkirchen (DE)

Correspondence Address: CLARIANT CORPORATION;INTELLECTUAL PROPERTY DEPARTMENT, 4000 MONROE ROAD, CHARLOTTE, NC, 28205, US

(73) Assignee: Clariant International Ltd.

(21) Appl. No.: 11/894,014

(22) Filed: Aug. 17, 2007

(30) Foreign Application Priority Data
Aug. 18, 2006 (DE) 10 2006 038 849.6

(51) Int. Cl. C08F 8/02

(52) U.S. Cl. 525/384

(57) ABSTRACT

The invention provides a process for preparing polyoxyalkylene glycol monoethers and/or diethers by reacting an alkoxide with an alkylating agent, which comprises adding water and block polymers which are obtainable from a compound which comprises from 1 to 30 carbon atoms and from 1 to 25 hydroxyl groups, amino groups or both by its blockwise alkoxylation with at least 2 different blocks of in each case from 1 to 200 mol of C₂- to C₄-alkylene oxide to the mixture of alkoxide, alkylating agent and polyoxyalkylene glycol ether which has formed.

The present invention relates to a process for preparing polyoxyalkylene glycol ethers using emulsion breakers.

The etherification of free OH groups in polyoxyalkylene glycols is effected on the industrial scale generally by the Williamson synthesis (K. Weissermel, H. J. Arpe “Industrielle Organische Chemie” [Industrial Organic Chemistry], 1998, page 179) by reacting a polyoxyalkylene glycol R—OH with sodium hydroxide or sodium to give the corresponding alkoxide and then alkylating with an alkyl chloride R¹-Cl according to the following reaction equations:

R—OH+NaOH→R—ONa+H₂O (I)

R—ONa+Cl—R¹→R—O—R¹+NaCl (II)

The salts which form are brought into solution by adding water and then isolated from the product by a phase separation. This time-consuming aqueous phase separation can, however, take several hours, especially in the case of mixed polyoxyalkylene glycol dialkyl ethers or pure polypropylene glycol dialkyl ethers, and hence leads to longer tank occupation times and correspondingly higher costs.

It was accordingly an object of the present invention to provide a process with which the phase separation of the water from polyoxyalkylene glycol dialkyl ethers proceeds more rapidly.

It has been found that, surprisingly, particular block polymers are suitable for accelerating the phase separation without having an adverse influence on the desired reaction product.

The invention thus provides a process for preparing polyoxyalkylene glycol monoethers and/or diethers by reacting an alkoxide with an alkylating agent, which comprises adding water and block polymers which are obtainable from a compound which comprises from 1 to 30 carbon atoms and from 1 to 25 hydroxyl groups, amino groups or both, by its blockwise alkoxylation with at least 2 different blocks of in each case from 1 to 200 mol of C₂- to C₄-alkylene oxide to the mixture of alkoxide, alkylating agent and polyoxyalkylene glycol ether which has formed.

The invention further provides for the use of block polymers which are obtainable from a compound which comprises from 1 to 30 carbon atoms and from 1 to 25 hydroxyl groups, amino groups or both by its blockwise alkoxylation with at least 2 different blocks of in each case from 1 to 200 mol of C₂- to C₄-alkylene oxide as demulsifiers in the process according to the invention.

The polyoxyalkylene glycol monoethers and/or diethers preparable by the process according to the invention correspond generally to the formula 1

R—O—(AO)_{y}—R¹ (1).

In this formula,
R is hydrogen, a hydrocarbon group having from 1 to 24 carbon atoms or an R*—C(O)— group where R* is a hydrocarbon group having from 1 to 24 carbon atoms,
R¹ is a hydrocarbon group having from 1 to 12 carbon atoms, AO is an alkoxy group, and
y is from 1 to 200.
y is preferably from 2 to 100, in particular from 3 to 50.

R may be of aliphatic or aromatic nature. R may be saturated or unsaturated. Examples of R are alkyl groups having from 1 to 24 carbon atoms, alkenyl groups having from 2 to 24 carbon atoms, phenyl, benzyl and allyl. R comprises preferably from 2 to 18, in particular from 4 to 12 carbon atoms.

When R in formula 2 is hydrogen, these compounds are polyoxyalkylene glycol monoethers which are obtainable by alkylating monoalkylene glycol, dialkylene glycol or higher alkylene glycols.

When R in formula 2 is a hydrocarbon group having from 1 to 24 carbon atoms, these compounds are polyoxyalkylene glycol diethers which are obtainable by alkylating alkoxylates of monoalcohols having from 1 to 24, preferably from 2 to 18, in particular from 4 to 12 carbon atoms.

When R in formula 2 is an R*—C(O)— group where R* is a hydrocarbon group having from 1 to 24 carbon atoms, these compounds are polyoxyalkylene glycol diethers which are obtainable by alkylating alkoxylates of monocarboxylic acids, where R* comprises from 1 to 24, preferably from 2 to 18, in particular from 4 to 12 carbon atoms.

R¹ is preferably a radical which is derived from hydrocarbyl halides having from 1 to 12, preferably from 2 to 8, in particular from 4 to 6, carbon atoms by abstraction of the halogen atom. R¹ may be of aliphatic or aromatic nature. R¹ may be saturated or unsaturated. Examples of R¹ are alkyl groups having from 1 to 12 carbon atoms, alkenyl groups having from 2 to 12 carbon atoms, phenyl, benzyl, allyl. The hydrocarbyl halide is the alkylating agent. Preferred halides are chlorides.

AO is a uniform or a mixed alkoxy group which may be arranged randomly or in blocks, and which may comprise ethoxy, propoxy and/or butoxy groups. In a preferred embodiment, AO comprises at least one propoxy or butoxy group.

Suitable block polymers correspond, for example, to the formula 2

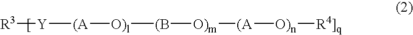

in which
A, B are various C₂- to C₄-alkylene groups
R³ is H or a hydrocarbon radical which has from 1 to 30 carbon atoms and may comprise heteroatoms
R⁴ is H or a C₁- to C₄-alkyl group
I, m are each independently from 1 to 200
n is from 0 to 200,
q is from 1 to 25, and
Y is O or NR⁵, and
R⁵ is as defined for R³.

When Y is NR⁵, it is preferred that the compounds of the formula (2) have at least two active hydrogen atoms, i.e. sites suitable for alkoxylation. Particular preference is given to those compounds in which q is equal to 2 or greater than 2, and to those compounds in which R³ and/or R⁵ bear(s) at least one hydroxyl group.

R³ is a hydrocarbon radical which has from 1 to 30 carbon atoms and may comprise heteroatoms such as oxygen and/or nitrogen. R³ may be substituted, in which case the preferred substituents are hydroxyl and amino groups. The substituents of R³ may bear alkoxy groups of the formula -(A-O)_{I}—(B—O)ₘ-(A-O)ₙ— where A, B, I, m, n are each as defined above. The carbon atoms present in these alkoxy groups are not included in the 1 to 30 carbon atoms that R³ can comprise.

I, m and n are each independently from 2 to 100. In a preferred embodiment, the alkoxy chain -(A-O)_{I}—(B—O)ₘ—(A-O)ₙ— contains more than 30 mol % of propylene oxide groups.

q is preferably from 2 to 20, in particular from 3 to 8.

The molecular weight of the compounds of the formula 3 is preferably between 1000 and 30 000 g/mol.

In a preferred embodiment, the compounds of the formula 3 are alkylene oxide polymers having a molar mass of from 1500 to 35 000, preferably from 2000 to 15 000, obtained by reacting a diol, polyol or amine with C₂-C₄-alkene oxides. Useful diols for the alkylene oxide polymers include the following products:
1. aliphatic diols, e.g. ethylene glycol, 1,2-propylene glycol, butanediol-1,4, dodecanediol-1,12, diethylene glycol, triethylene glycol, dipropylene glycol, polyethylene glycols having relative molar masses up to approx. 20 000, polypropylene glycols having relative molar masses up to approx. 4000, polybutylene glycols having relative molar masses up to approx. 4000.
2.ethylene oxide-propylene oxide block polymers which are prepared by oxyethylating a polypropylene oxide having a molar mass of at least 600, preferably starting from a polypropylene oxide having a molar mass of from 600 to 3500. The propylene oxide may also be replaced partly by butylene oxide. The proportion of the polyethylene oxide groups in the overall molecule of the block polymer is selected such that it makes up at least 5%, preferably 10-80%.
3. ethylene oxide-butylene oxide block polymers which are prepared by oxyethylating a polybutylene oxide having a molar mass of at least 600, preferably starting from a polybutylene oxide having a molar mass of 600-3000; the butylene oxide may also be replaced partly by propylene oxide; the proportion of polyethylene oxide groups in the overall molecule of the block polymer is selected such that it is at least 10%, preferably from 10 to 80%.

Suitable polyols are, for example, glycerol, diglycerol, triglycerol, polyglycerols, trimethylolpropane, pentaerythritol, dipentaerythritol, sorbitol, mannitol and further reduced sugars. Amines suitable for the preparation of such block polymers are, for example, ethylenediamine, diethylenetriamine, triethylenetetramine, tetraethylenepentamine and their higher homologs, triethanolamine and tris(hydroxymethyl)aminomethane.

The block polymers can also be used in crosslinked form in the process according to the invention. The crosslinked block polymers are obtainable from the block polymers by reaction with bi-, tri- and tetraglycidyl ethers, by esterification with polybasic dicarboxylic acids and their anhydrides, and by reaction with polyvalent isocyanates.

The following crosslinkers are used with preference: bisphenol A diglycidyl ether, butane-1,4-diol diglycidyl ether, hexane-1,6-diol diglycidyl ether, ethylene glycol diglycidyl ether, cyclohexanedimethanol diglycidyl ether, resorcinol diglycidyl ether, glyceryl diglycidyl ether, glyceryl triglycidyl ether, glyceryl propoxylate triglycidyl ether, polyglyceryl polyglycidyl ether, p-aminophenol triglycidyl ether, polypropylene glycol diglycidyl ether, pentaerythrityl tetraglycidyl ether, sorbitol polyglycidyl ether, trimethylolpropane triglycidyl ether, castor oil triglycidyl ether, diaminobiphenyl tetraglycidyl ether, soybean oil epoxide, adipic acid, maleic acid, phthalic acid, maleic anhydride, succinic anhydride, dodecylsuccinic anhydride, phthalic anhydride, trimellitic anhydride, pyromellitic anhydride, toluene diisocyanate, diphenylmethane diisocyanate.

The crosslinked block polymers described may also be used in alkoxylated form in the process according to the invention. To this end, they are alkoxylated preferably with from 5 to 700 g of a C₂- to C₄-alkylene oxide, in particular from 30 to 300 g, per 100 g of crosslinked block polymer. Particularly suitable block polymers for the alkoxylation are crosslinked block polymers obtained by reaction with glycidyl ethers, specifically block polymers crosslinked with diglycidyl ethers.

In addition to block polymers, it is also possible to use codemulsifiers in the process according to the invention. Such codemulsifiers are
a) alkoxylated alkylphenol-aldehyde resins
b) alkoxylated polyethyleneimines

or mixtures thereof.

Alkoxylated alkylphenol-aldehyde resins are understood to mean in particular compounds of the formula 3

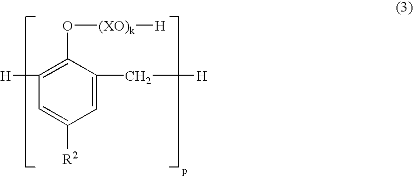

in which

R² is a straight-chain or branched C₁- to C₂₀-alkyl radical,

p is from 1 to 75,

X is one 1,2-alkylene group or different 1,2-alkylene groups having from 2 to 4 carbon atoms, and

k is from 1 to 200.

R² is preferably a C₄- to C₁₂-alkyl radical.

p is preferably from 2 to 40.

k is preferably from 5 to 150, in particular from 10 to 100.

X is preferably ethylene or propylene groups.

The alkoxylated alkylphenol-aldehyde resins of the formula 1 are obtainable by known processes by condensing the corresponding alkylphenols with formaldehyde, i.e. with from 0.5 to 1.5 mol, preferably from 0.8 to 1.2 mol, of formaldehyde per mole of alkylphenol. The condensation can be effected without solvent, but is preferably effected in the presence of a water-immiscible or only partly water-miscible inert organic solvent such as mineral oils, alcohols, ethers and the like. Particular preference is given to solvents which can form azeotropes with water. The solvents of this type used are in particular aromatics such as toluene, xylene, diethylbenzene, relatively high-boiling commercial solvent mixtures, for example Solvent Naphtha, or glymes (polyethylene glycol dialkyl ethers). The condensation is effected preferably between 70 and 200° C., in particular between 90 and 160° C. They are catalyzed typically by from 0.05 to 5% by weight of bases or acids. After the alkylphenol-aldehyde resin has been prepared, it is alkoxylated with a C₂- to C₄-alkylene oxide, so that the resulting alkoxylate contains from 1 to 200 alkoxy groups.

Suitable demulsifiers b) are oligo- or polyethyleneimines which are alkoxylated with from 1 to 100 C₂- to C₄-alkylene oxide groups or a mixture of such alkylene oxide groups per free NH group.

The precursors of the alkoxylated oligo- and polyethyleneimines are branched, oligomeric or polymeric amines in which two carbon atoms are always followed by a nitrogen atom. The ratio of primary to secondary to tertiary nitrogen atoms is preferably—as is customary in the corresponding commercial products—about 1:2:1. As polymers, they have a molecular weight distribution. In the context of the present invention, preference is given to using those types whose mean molar masses (M_{w} measured by means of light scattering) are greater than 15 000 g/mol. The following formula 4 illustrates the structure of commercial branched polyethyleneimines in which the ratio of primary to secondary to tertiary nitrogen atoms is about 1:2:1:

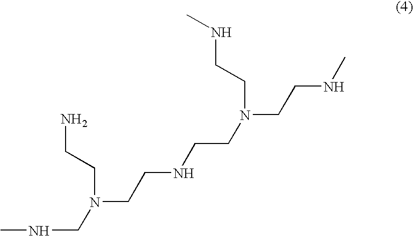

The oligo- or polyethyleneimine is, as known in the prior art, alkoxylated with C₂-C₄-alkylene oxides or a mixture of such alkylene oxides, so that the alkoxylated oligo- or polyethyleneimine has a preferred degree of alkoxylation of from 2 to 80 alkylene oxide units per free NH group. In particular, the alkoxylated oligo- or polyethyleneimines used are prepared by sequential alkoxylation of ethylene oxide, propylene oxide and/or butylene oxide under alkaline catalysis. Preference is given to those alkoxylated oligo- or polyethyleneimines which are prepared by alkoxylation first with propylene oxide (PO) and then with ethylene oxide (EO). The following structural formulae illustrate, by way of example, the structure of an alkoxylated oligo- (5) or polyethyleneimine (6) used with preference:

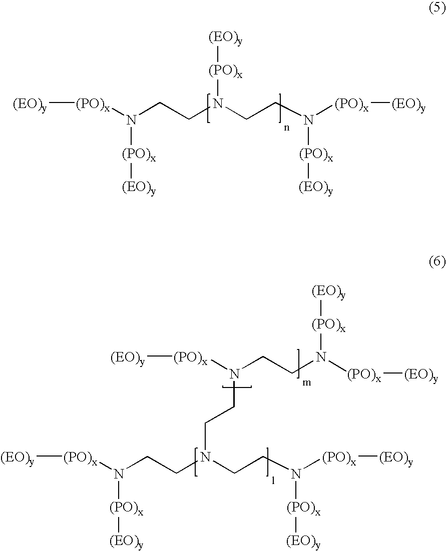

in which 1, m and n are each independently from 0 to 1000 and (x+y) is equal to from 1 to 1000.

The alkoxylated oligo- or polyethyleneimines d) generally have a molecular weight of more than 25 000 g/mol, preferably from 25 000 to 1 000 000 g/mol, in particular from 25 000 to 250 000 g/mol, measured by means of gel permeation chromatography (GPC) against polyethylene glycol in tetrahydrofuran.

The inventive emulsion breakers are preferably added in solution. The solvents used are either any organic solvents, for example alkanes or aromatics, or water, or else the product to be broken itself. In this process, preferably no residues of the emulsion breaker and of the solvent should remain in the polyalkylene glycol ether, but rather only in the aqueous phase. Preference is therefore given to using water-soluble breakers. The emulsion breakers are added in amounts of from 0.0001 to 5% by weight, in particular from 0.001 to 0.01 % by weight, based on the total amount of the reaction mixture (i.e. crude product+salt burden+water).

The process according to the invention will now be illustrated in detail using a few examples:

### EXAMPLES

### Example 1: (Comparative)

Preparation of Polypropylene Glycol Allyl Butyl Ether without Breaker Addition

In a stirred reactor with temperature and pressure monitoring, 96.4 g of a polypropylene glycol allyl ether having a mean molar mass of 1400 g/mol are admixed with 6.43 g of sodium hydroxide at 80° C. with stirring under nitrogen. Subsequently, 19.28 g of butyl chloride are added dropwise within one hour. The reactor is heated to 120° C. for postreaction and stirred at this temperature for another three hours. Subsequently, excess butyl chloride is distilled off and cooled to 90° C. With stirring, exactly the amount of water required to bring the amount of sodium chloride into solution is added.

### Example 2

Preparation of Polypropylene Glycol Allyl Butyl Ether with Breaker Addition

The procedure is as in Example 1, with the difference that 50 ppm of a block addition product of 40% by weight of ethylene oxide and 60% by weight of propylene oxide to propylene glycol have additionally been added to the aqueous polypropylene glycol allyl butyl ether.

### Example 3 (Comparative)

Preparation of Polyalkylene Glycol Allyl Butyl Ether without Breaker Addition

In a stirred reactor with temperature and pressure monitoring, 96.5 g of a polyalkylene glycol allyl ether having a mean molar mass of 1600 g/mol and a mixing ratio of ethylene glycol to propylene glycol of 3 to 1 are admixed with 3.7 g of sodium hydroxide at 80° C. with stirring under nitrogen. Subsequently, 11.6 g of butyl chloride are slowly added dropwise. The reactor is heated to 120° C. for postreaction and stirred at this temperature for three hours. Subsequently, excess butyl chloride is distilled off and the mixture is cooled to 90° C. With stirring, exactly the amount of water required to bring the amount of sodium chloride into solution is added.

### Example 4

Preparation of Polyalkylene Glycol Allyl Butyl Ether with Breaker Addition

The procedure is as in Example 3, with the difference that 50 ppm of a block addition product of 40% by weight of ethylene oxide and 60% by weight of propylene oxide to propylene glycol, which has been crosslinked with bisphenol A diglycidyl ether up to a molecular weight Mw of 10 000 g/mol (measured by GPC), have additionally been added to the aqueous polyalkylene glycol allyl butyl ether.

### Example 5 (Comparative)

Preparation of Polyalkylene Glycol Allyl Methyl Ether without Breaker Addition

In a stirred reactor with temperature and pressure monitoring, 99.6 g of a polyalkylene glycol allyl ether having a mean molar mass of 2000 g/mol and a mixing ratio of ethylene glycol to propylene glycol of 1 to 1 are admixed with 0.75 g of sodium hydroxide at 80° C. with stirring under nitrogen. Subsequently, 0.95 g of methyl chloride is slowly added dropwise. The reactor is heated to 120° C. for postreaction and stirred at this temperature for a further three hours. Thereafter, excess butyl chloride is distilled off and the mixture is cooled to 90° C. With stirring, the amount of water required to bring the amount of sodium chloride into solution is added.

### Example 6

Preparation of Polyalkylene Glycol Allyl Methyl Ether with Breaker Addition

The procedure is as in Example 5, with the difference that 50 ppm of a block addition product of 40% by weight of ethylene oxide and 60% by weight of propylene oxide to propylene glycol, which has been crosslinked with bisphenol A diglycidyl ether up to a molecular weight Mw of 10 000 g/mol (measured by GPC), and has subsequently been propoxylated with 30 mol of propylene oxide, have additionally been added to the aqueous polyalkylene glycol allyl methyl ether.

Results of the Phase Separation Experiments:

To determine the effectiveness of the emulsion breaker, the water separation from the crude product emulsion was determined as a function of time. To this end, in each case 100 ml of the crude product emulsion were introduced into breakage bottles (conical, screw-closeable, graduated glass vessels). Thereafter, the breakage bottles were placed into a temperature-controlled bath and the water separation was monitored at 80° C.

TABLE 1

| | Water separation [ml] per unit time | | | | | | | | | |
|---|---|---|---|---|---|---|---|---|---|---|
| Ex. | 10 min | 30 min | 60 min | 2 h | 3 h | 4 h | 5 h | 6 h | 12 h | 24 h |
| 1 | 0 | 0 | 0 | 2 | 4 | 6.5 | 9 | 11.5 | 16.5 | complete |
| 2 | 2 | 4 | 8 | 10 | 13.5 | 16 | 17.5 | complete | | |
| 3 | 0 | 0 | 0 | 0 | 1 | 1 | 2.5 | 4 | 7 | 12.5 |
| 4 | 2 | 2.5 | 9 | 12.5 | 14.5 | 18 | complete | | | |
| 5 | 0 | 0 | 0 | 0 | 0 | 0 | 0 | 1 | 3 | 4.5 |
| 6 | 5 | 11 | 16 | complete | | | | | | |

1. A process for preparing a polyoxyalkylene glycol monoether or a diether or a mixture thereof, said process comprising reacting a mixture comprising an alkoxide and an alkylating agent, said reacting comprising adding to said mixture water and a block polymer which is obtained from a compound which comprises from 1 to 30 carbon atoms and from 1 to 25 hydroxyl groups, amino groups or both by its blockwise alkoxylation with at least 2 different blocks of in each case from 1 to 200 mol of C₂- to C₄-alkylene oxide.

2. The process as claimed in claim 1, in which the polyoxyalkylene glycol monoether or diether or mixture thereof corresponds to formula 2
R—O-(AO)_{y}—R¹ (2)
in which
R is hydrogen, a hydrocarbon group having from 1 to 24 carbon atoms or an R*—C(O)— group where R* is a hydrocarbon group having from 1 to 24 carbon atoms,
R¹ is a hydrocarbon group having from 1 to 12 carbon atoms,
AO is an alkoxy group, and
y is from 1 to 200.

3. The process as claimed in claim 2, in which y is from 2 to 100.

4. The process of claim 2 in which R is a group selected from the group consisting of an alkyl group having from 1 to 24 carbon atoms, an alkenyl group having from 2 to 24 carbon atoms, a group of the formula R*—C(O)— where R* is a hydrocarbon group having from 1 to 24 carbon atoms,
a phenyl group, a benzyl group, an allyl group and mixtures thereof.

5. The process of claim 2, in which R comprises from 4 to 12 carbon atoms.

6. The process of claim 2, in which R¹ is selected from the group consisting of an alkyl having from 1 to 12 carbon atoms, an alkenyl having from 2 to 12 carbon atoms, a phenyl, a benzyl, an allyl and mixtures thereof.

7. The process of claim 2, in which R¹ comprises from 2 to 8 carbon atoms.

8. The process of claim 2, in which AO comprises at least one propoxy or butoxy group.

9. The process of claim 1, in which the block polymer corresponds to the formula 3 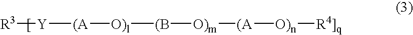
in which
A, B are various C₂- to C₄-alkylene groups
R³ is H or a hydrocarbon radical which has from 1 to 30 carbon atoms and optionally comprises a heteroatom
R⁴ is H or a C₁- to C₄-alkyl group
I, m are each independently from 1 to 200
n is from 0 to 200,
q is from 1 to 25, and
Y is O or NR⁵, and
R⁵ is as defined for R³.

10. The process as claimed in claim 9, in which Y is NR⁵, the compound of the formula (3) has at least two active hydrogen atoms, and in which q is equal to 2 or greater than 2.

11. The process as claimed in claim 9, in which R³ bears alkoxy groups of the formula -(A-O)_{I}—(B—O)ₘ-(A-O)ₙ—.

12. The process of claim 9, in which q is from 2 to 20.

13. The process of claim 1, in which the block polymer is crosslinked to provide a crosslinked block polymer.

14. The process as claimed in claim 13, in which the crosslinked block polymer is used in alkoxylated form, wherein the alkoxylation is performed with from 5 to 700 g of a C₂- to C₄-alkylene oxide per 100 g of crosslinked block polymer.

15. The process of claim 1, wherein the mixture further comprises a codemulsifier selected from the group consisting of
a) an alkoxylated alkylphenol-aldehyde resin
b) an alkoxylated polyethyleneimine, and a mixture thereof.

16. The process of claim 13, wherein the crosslinked block polymer is crosslinked by the reaction of the block polymer with an compound selected from the group consisting of a bi-glycidyl ether, a tri-glycidyl ether, a tetraglycidyl ether and mixtures thereof; or by esterification with a polybasic dicarboxylic acid or an anhydride of the dicarboxylic acid, or a mixture thereof; or by reaction with a polyvalent isocyanate.

17. The process of claim 14, wherein the alkoxylation is performed with from 30 to 300 g per 100 g of the crosslinked block polymer.
